(19) United States
(12) Patent Application Publication
(10) Pub. No.: US 2008/0129724 A1
(43) Pub. Date: Jun. 5, 2008

(54) Image Editing

(75) Inventors: Stanley S. Cleveland, Beaverton, OR (US); Todd I. Long, Forest Grove, OR (US)

Correspondence Address: BANNER & WITCOFF, LTD., 1100 13th STREET, N.W., SUITE 1200, WASHINGTON, DC, 20005-4051, US

(73) Assignee: Nike, Inc., Beaverton, OR (US)

(21) Appl. No.: 11/566,435

(22) Filed: Dec. 4, 2006

(51) Int. Cl. G06T 15/00; G06F 17/50

(52) U.S. Cl. 345/419; 703/1

(57) ABSTRACT

Systems and methods are shown for creating images of footwear. A computer device may execute an automation script or program to coordinate the function of multiple applications to manipulate the data and images used to produce variations of digital images. The automation script or program may access design element sources. Design elements may include color data, material images and base footwear images. The automation script or program may read data from a request file and manipulate an image editing application to assemble the design elements identified in the data request file to generate one or more footwear images.

### FIELD OF THE INVENTION

The invention relates to systems and methods used to create digital images of footwear. More particularly, the invention provides methods and systems for creating multiple images of footwear utilizing collections of design elements and a data file.

### BACKGROUND OF THE INVENTION

Computer devices have been used to create digital images of footwear. Digital images are used by designers and others to represent an article of footwear without undertaking the expensive and time consuming process of creating an actual article of footwear. Conventional processes include starting with an original image and then modifying the image with an image editing application, such as Adobe Photoshop. Modifications may include changing colors, materials and other aspects of the image.

Existing manual processes for editing images of footwear are time consuming and labor intensive. Moreover, footwear designers are typically not the same people who perform image editing. As a result, communication issues can result in images being created that are not in compliance with design specifications. These limitations become magnified as the design of footwear becomes more complex. Athletic footwear, for example, may contain several layered sections that may be made of a variety of materials having assorted colors and textures. Corresponding images can be time consuming to create and are more likely to contain errors than simpler designs.

Therefore, there is a need in the art for systems and methods that facilitate creating images of footwear quickly, with limited human involvement and with low error rates.

### SUMMARY OF THE INVENTION

One or more of the above-mentioned needs in the art are satisfied by the disclosed systems and methods for creating images of footwear. An electronic data file may be used to identify visual attributes of footwear. An imaging editing application may retrieve design elements, such as colors, material images and base footwear images and create one or more footwear images. The image editing application may be controlled by a script.

In certain embodiments of the invention, the present invention can be partially or wholly implemented with a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention is illustrated by way of example and not limited in the accompanying figures in which like reference numerals indicate similar elements and in which:

FIG. 1 illustrates a system for creating images of articles of footwear, in accordance with an embodiment of the invention;

FIG. 2 illustrates a grayscale image of footwear, in accordance with an embodiment of the invention;

FIG. 3 illustrates an image of an article of footwear created in accordance with embodiments of the invention; and

FIG. 4 illustrates an automated method of creating images of footwear, in accordance with an embodiment of the invention.

### DETAILED DESCRIPTION OF THE INVENTION

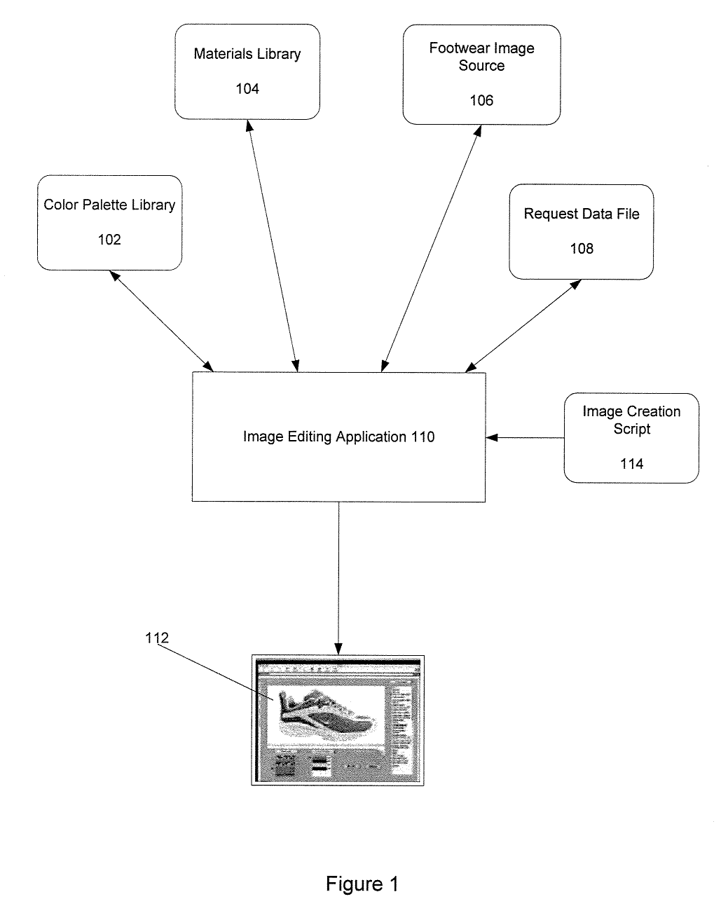

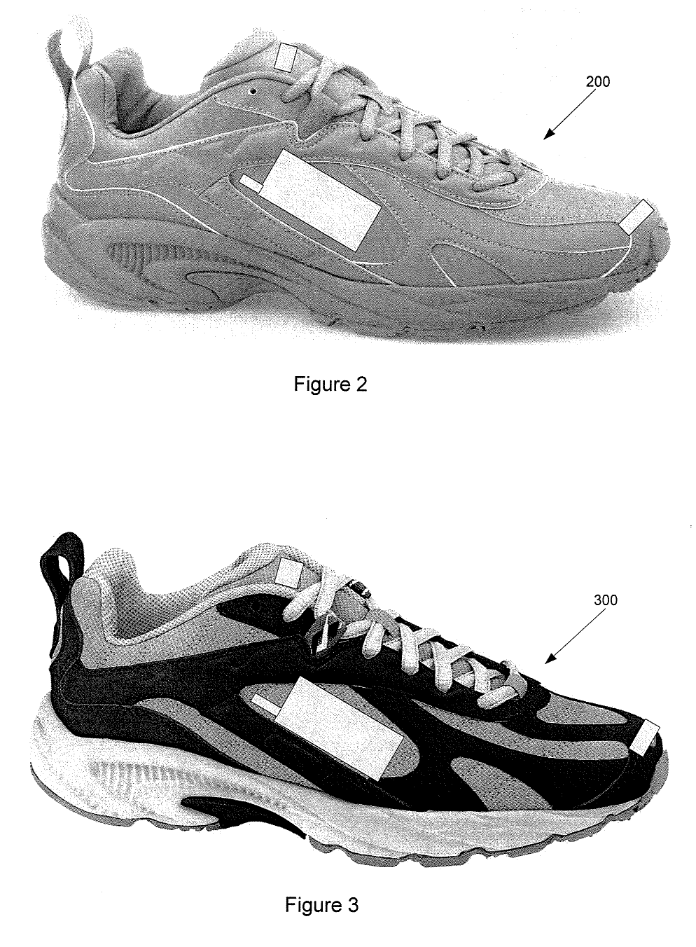

FIG. 1 illustrates a system for creating images of footwear in accordance with an embodiment of the invention. The system show in FIG. 1 may be implemented with one or more computer devices having elements connected by a local area network (LAN), a wide area network (WAN) or both. Each computer device may include a processor, memory, keyboard, pointing device and other conventional computer device components. The computer devices may be controlled by computer-executable instructions stored on computer-readable media, such as an optical disk, magnetic memory or physical memory.

The system shown in FIG. 1 includes a color palette library 102 that may contain color values. Individual color values may be arranged in a database, such as a FileMaker Pro database. In one embodiment, the color values have four channels such as CMYK color values. The individual color values may correspond to colors available to designers. A materials library 104 may contain images of materials that may be used in the design of footwear. The materials may have a variety of textures and other visually perceptive characteristics. In one embodiment, the images included within materials library 104 have a size that is greater than the size of the resulting footwear image. This prevents the need to tile or otherwise piece together individual images and facilitates further processing described below.

A footwear image source 106 may include a plurality of base footwear images used in the design of footwear. Gray base images may be created by digitally changing the color of existing images. Material may be visually removed from the gray base images resulting in a base image that has only shape, highlight and shadow. Base images may also be mapped with vector path outlines that correspond to image components.

A request data file 108 may include data that identifies design characteristics of one or more articles of footwear. Request data file 108 may identify all of the information necessary to create one or more images of footwear, such as specific materials, colors, locations within a base footwear image and other characteristics. In one embodiment of the invention, request data file 108 includes information describing a plurality of variations in the design of an article of footwear. For example, request data file may include information regarding ten different images of footwear that are each based on the same base image, using different materials and colors. Data file 108 may be a spreadsheet file.

An image editing application 110 may be linked to color palette library 102, materials library 104, footwear image source 106 and request data file 108. Image editing application 110 may include computer-executable instructions for retrieving data from some or all of the sources and creating an image of an article footwear such as image 112. In one embodiment, an image creation script 114 is used to control the process performed by image editing application 110. For example, image creation script 114 may describe how image editing application 110 combines all of the data received from the sources described above. In one embodiment of the invention, image editing application 110 is implemented with Adobe Photoshop and image creation script 114 is a script written with AppleScript scripting language.

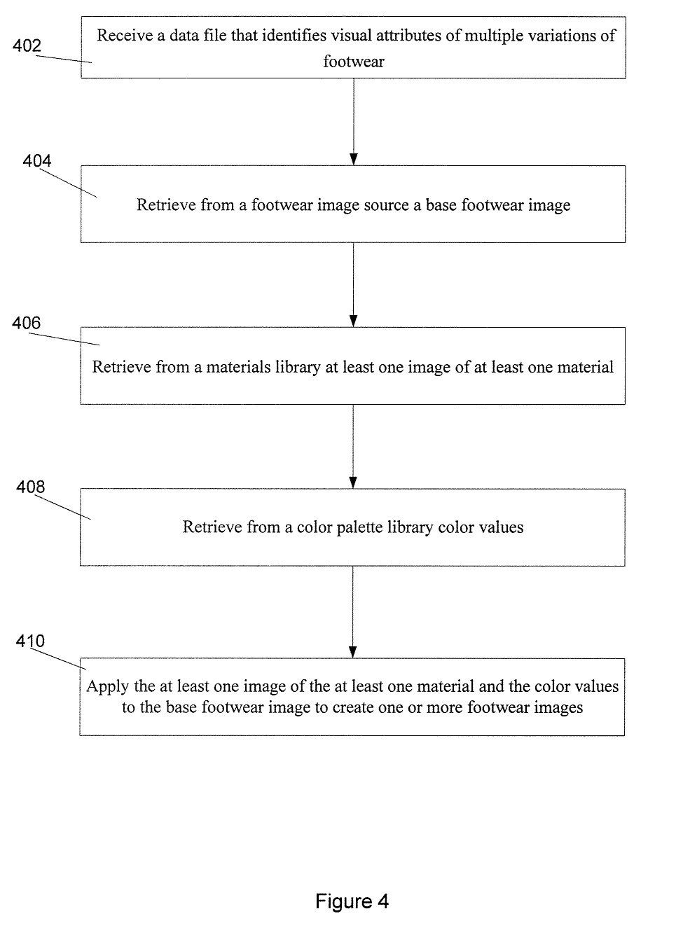

FIG. 4 illustrates a method of creating images of footwear, in accordance with an embodiment of the invention. The steps identified in FIG. 4 may be performed with a system such as the system shown in FIG. 1. First, in step 400 a data file that identifies visual attributes of multiple variations of footwear is received. The data file may be similar to request data file 108. Next, a base footwear image is retrieved from a footwear image source. The base footwear image may be identified in the data file and may be edited to produce a gray image that will be modified.

Next, in step 406 images of materials are retrieved from a materials library. The materials may be used to provide texture and other visually perceptible attributes. Color values may be retrieved from a color palette library in step 408. The color values may be identified in the data file to be used to subsequently color an image.

Finally, in step 410 images of the materials and color values are applied to the base footwear image to create one or more footwear images. Step 410 may be performed by an image editing application, such as image editing application 110 and the process may be controlled by a script, such as image creation script 114. Step 410 may also include applying images of materials as overlays to the base footwear image to preserve shadows, highlights and details of the base footwear image.

The image creation step may utilize a variety of existing and conventional image processing tools. For example, an alpha mask may be used to create a selection of the contour of an article of footwear and a distortion filter, such as the Adobe Photoshop spherize filter, may be used to wrap a material image around a base image. Metallic silver colors may also be created by applying a contrast adjustment curve to generate the appearance of reflection. FIG. 3 shows an article of footwear 300 created with the method shown in FIG. 4.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A computer-implemented method of creating images of footwear, the method comprising:
(a) receiving a data file that identifies visual attributes of multiple variations of footwear;
(b) retrieving from a footwear image source a base footwear image identified in the data file;
(c) retrieving from a materials library at least one image of at least one material identified in the data file;
(d) retrieving from a color palette library color values identified in the data file; and
(e) applying the at least one image of the at least one material and the color values to the base footwear image to create multiple footwear images.

2. The method of claim 1, wherein the data file is in a spreadsheet format.

3. The method of claim 1, wherein the base footwear image has a gray color.

4. The method of claim 1, wherein the base image is mapped with vector path outlines that correspond to image components identified in the data file.

5. The method of claim 1, wherein (c) comprises retrieving from the materials library multiple images of multiple materials identified in the data file and (e) comprises applying the multiple images of multiple materials and the color values to the base footwear image to create multiple footwear images.

6. The method of claim 1, wherein the color palette library comprises a database.

7. The method of claim 6, wherein the database contains CMYK color values.

8. The method of claim 1, wherein the process for performing (e) is identified in an image creation script.

9. The method of claim 8, wherein the image creation script causes an image editing application to perform (e).

10. The method of claim 1, wherein (e) further includes applying a distortion filter process after the at least one image of the at least one material is applied to the base footwear image.

11. The method of claim 1, wherein the at least one image retrieved from the materials library is larger in size than the base footwear image.

12. The method of claim 1, wherein (e) further includes applying an alpha mask to create a selection of the contours of the base footwear image.

13. The method of claim 1, further including applying a contrast adjustment curve to at least a portion of one of the multiple footwear images to create an appearance of a reflective surface.

14. The method of claim 1, wherein (e) comprises applying the at least one image of the at least one material as an overlay to the base footwear image to preserve shadows, highlights and details of the base footwear image.

15. A computer-readable medium containing computer-executable instructions for performing the steps comprising:
(a) receiving a data file that identifies visual attributes of multiple variations of footwear;
(b) retrieving from a footwear image source a base footwear image identified in the data file;
(c) retrieving from a materials library at least one image of at least one material identified in the data file;
(d) retrieving from a color palette library color values identified in the data file; and
(e) applying the at least one image of the at least one material and the color values to the base footwear image to create multiple footwear images.

16. The computer-readable medium of claim 15, wherein (c) comprises retrieving from the materials library multiple images of multiple materials identified in the data file and (e) comprises applying the multiple images of multiple materials and the color values to the base footwear image to create multiple footwear images.

17. The computer-readable medium of claim 15, wherein (e) comprises applying the at least one image of the at least one material as an overlay to the base footwear image to preserve shadows, highlights and details of the base footwear image.

18. A system for creating images of footwear, the system comprising:
a footwear image source containing a collection of base footwear images;
a materials library containing a collection of images of materials;
a color palette library containing a collection of color values; and
a computer device programmed with computer-executable instructions to perform the steps comprising:
(a) receiving a data file that identifies a base footwear image, at least one material image and at least one color value; and
(b) applying the at least one material image and the at least one color value to the base footwear image to create multiple footwear images.

19. The system of claim 1, wherein (b) comprises applying the at least one material image as an overlay to the base footwear image to preserve shadows, highlights and details of the base footwear image.

20. The system of claim 1, wherein the base footwear image has a gray color.
